(19) United States
(12) Patent Application Publication
(10) Pub. No.: US 2014/0018997 A1
(43) Pub. Date: Jan. 16, 2014

(54) VEHICLE ODOMETER AND TRIP DATA COLLECTION DEVICE

(71) Applicants: Roger Lloyd Sawhill, Lawrenceville, GA (US); Mark Steven Braught, Commerce, GA (US); Mark Laverne Robertson, Greensboro, NC (US)

(72) Inventors: Roger Lloyd Sawhill, Lawrenceville, GA (US); Mark Steven Braught, Commerce, GA (US); Mark Laverne Robertson, Greensboro, NC (US)

(73) Assignee: R MARK TWO, LLC, Lawrenceville, GA (US)

(21) Appl. No.: 12/030,554

(22) Filed: Feb. 13, 2008

Related U.S. Application Data
(60) Provisional application No. 60/945,950, filed on Jun. 25, 2007.

(51) Int. Cl. G07C 5/08

(52) U.S. Cl. CPC G07C 5/08
USPC 701/29.1

(57) ABSTRACT

The technology described herein provides a vehicle odometer and trip data collection system for use in a motor vehicle. The vehicle odometer and trip data collection system provides automated data collection, user input data collection via a user interface panel, data authentication, and data retrieval. The vehicle odometer and trip data collection system provides connectivity to NIST atomic clock transmissions and global positioning satellite systems. In one embodiment, this technology provides vehicle monitoring utilizing an interface unit, a removable memory unit, wireless transmission protocols, and radio frequency power harvesting.

### CLAIM TO PRIORITY

Applicants hereby claim priority under all rights to which they are entitled under 35 U.S.C. Section 120 based upon the U.S. Provisional Application Ser. No. 60/945,950 for this patent application filed at the United States Patent and Trademark Office on Jun. 25, 2007.

### FIELD OF THE INVENTION

The technology described herein relates generally to systems and methods for vehicle monitoring. More specifically, the technology described herein relates to a vehicle odometer and trip data collection device for automated data collection, user input data collection, data authentication, and data retrieval. Additionally, this technology relates to vehicle monitoring utilizing an interface unit, a removable memory unit, wireless transmission protocols, and radio frequency (RF) power harvesting.

### BACKGROUND OF THE INVENTION

It is often desired to record vehicle travel data for a particular vehicle and create an electronic log of all travel and trip related data. Such information is useful, for example, to record and identify business, medical, charitable, or other deductible mileage to meet requirements for federal and state tax deduction purposes. Such information is also useful to record and identify mileage for travel reimbursement. Also, such information is also useful to record and identify mileage between varying destinations for either personal and/or business purposes.

Vehicle data collection systems are known in the art which record and store travel data while a vehicle is in use. However, there are many deficiencies with these known systems. Since manual recordation of such data is tedious and time-consuming, it is desired to automate the vehicle travel data collection process.

Automated data collection is desired to receive and record data from vehicle sensors, receive and record time and date data from both the vehicle and other external sources, store accumulated data internally, provide transferability of data to other devices, allow internal software to be uploaded and/or updated, provide audio and/or visual alerts to a user, receive and record global positioning system (GPS) signal data, and to provide for the calculation, sorting, and formatting of data stored and received by the device.

Additionally, it is desired to provide a user with an ability to input data in addition to the data collected automatically. Additionally, it is desirous to authenticate such data to assure validity of data inputs and time and date stamps. Furthermore, it is desired to utilize a low-power system for vehicle trip data collection.

These and other problems exist. Previous attempts to solve these and other problems include the following.

U.S. Pat. No. 4,067,061, issued to Juhasz on Jan. 3, 1978, discloses a vehicle trip computer.

U.S. Pat. No. 4,188,618, issued to Weisbart on Feb. 12, 1980, discloses a digital tachograph system with a digital memory.

U.S. Pat. No. 4,192,006, issued to Hausdorff on Mar. 4, 1980, discloses a portable travel expense tabulator.

U.S. Pat. No. 4,371,934, issued to Wahl et al. on Feb. 1, 1983, discloses a vehicle trip computer.

U.S. Pat. No. 4,547,781, issued to Gelhorn et al. on Oct. 15, 1985, and U.S. Pat. No. 4,755,832, issued to Gulas et al. on Jul. 5, 1988 each discloses a device for recording distances traveled on personal and business use.

U.S. Pat. No. 4,852,000, issued to Webb et al. on Jul. 25, 1989, discloses a method for expense report storage and calculation.

U.S. Pat. No. 4,875,167, issued to Price et al. on Oct. 17, 1989, discloses an odometer data computing apparatus.

U.S. Pat. No. 5,267,159, issued to O'Neall on Nov. 30, 1993, discloses a mileage recording and display apparatus.

U.S. Pat. No. 5,337,236, issued to Fogg et al. on Aug. 9, 1994, discloses a system for categorizing and recording vehicle trip distance.

U.S. Pat. No. 5,428,542, issued to Liesveld on Jun. 27, 1995, discloses a vehicle mileage and information recording method and system.

U.S. Pat. No. 5,550,738, issued to Bailey et al. on Aug. 27, 1996, discloses a system for recording and analyzing vehicle trip data.

U.S. Pat. No. 5,557,524, issued to Maki on Sep. 17, 1996, discloses a GPS/GLONASS travel recorder.

U.S. Pat. No. 5,579,242, issued to Fisher on Nov. 26, 1996, discloses a system for electronic recording and accounting of motor vehicle mileage.

U.S. Pat. No. 5,787,373, issued to Migues et al. on Jul. 28, 1998, discloses a travel expense tracking system.

U.S. Pat. No. 5,862,500, issued to Goodwin on Jan. 19, 1999, discloses an apparatus and method for recording motor vehicle travel information.

U.S. Pat. No. 5,893,893, issued to Holt et al. on Apr. 13, 1999, discloses a device for the computerized recording of mileage and expenses in vehicles.

U.S. Pat. No. 6,064,929, issued to Migues et al. on May 16, 2000, discloses a travel expense tracking system.

U.S. Pat. No. 6,088,636, issued to Chigumira et al. on Jul. 11, 2000, discloses a vehicle trip data computer.

U.S. Pat. No. 6,301,533, issued to Markow on Oct. 9, 2001, discloses a business trip computer.

U.S. Pat. No. 6,434,510, issued to Callaghan on Aug. 13, 2002, discloses a vehicle accessory for monitoring travel distance.

U.S. Pat. No. 6,442,526, issued to Vance et al. on Aug. 27, 2002, discloses a system for corporate travel planning and management.

U.S. Pat. No. 6,622,083, issued to Knockeart et al. on Sep. 16, 2003, discloses a portable driver information device.

U.S. Pat. No. 6,778,900, issued to Tengler et al. on Aug. 17, 2004, discloses a vehicle mileage logging system.

U.S. Pat. No. 6,856,933, issued to Callaghan on Feb. 15, 2005, discloses a vehicle accessory for monitoring travel distance.

U.S. Pat. No. 6,975,929, issued to Maruyama on Dec. 13, 2005, discloses a data recording apparatus, data recording method, program for data recording and information recording medium.

U.S. Published Patent Application No. 2003/0023464, filed by Dombroski al. and published on Jan. 30, 2003, discloses a system, method, and computer program product for tracking performance of distributors in a supply chain management framework.

U.S. Published Patent Application No. 2005/0015316, filed by Salluzzo and published on Jan. 20, 2005, discloses methods for calendaring, tracking, and expense reporting, and devices and systems employing the same.

The foregoing patent and other information reflect the state of the art of which the inventors are aware and are tendered with a view toward discharging the inventors' acknowledged duty of candor in disclosing information that may be pertinent to the patentability of the technology described herein. It is respectfully stipulated, however, that the foregoing patent and other information do not teach or render obvious, singly or when considered in combination, the inventors' claimed invention.

### BRIEF SUMMARY OF THE INVENTION

In various exemplary embodiments, the technology described herein provides a vehicle odometer and trip data collection system for use in a motor vehicle. The vehicle odometer and trip data collection system provides automated data collection, user input data collection, data categorization, data authentication, and data retrieval. The vehicle odometer and trip data collection system, in various embodiments, provides connectivity to systems such as NIST atomic clock transmissions and global positioning satellite systems. Additionally, this technology provides vehicle monitoring utilizing an interface unit, a removable memory unit, wireless transmission protocols, and radio frequency power harvesting. Other comparable uses are also contemplated herein, as will be obvious to those of ordinary skill in the art.

The automated data collection includes, in various embodiments, time and date data, vehicle odometer values, and GPS coordinates. In various embodiments, the sources for time and date data collection include NIST atomic clock transmissions, GPS satellite transmissions, cellular network transmissions, proprietary network transmissions, and vehicle on-board computers. In various embodiments, the sources for vehicle odometer values include on-board vehicle electronic systems (On Board Diagnostic OBD) port data feeds, direct connection to a vehicle on-board computer, and mechanical and electrical sensors mounted to the vehicle. In various embodiments, the sources for GPS coordinates (latitude and longitude values) include the direct receipt of GPS satellite transmissions and “pinging” fixed location transmission towers.

The user input data entry includes, in various embodiments, a direct user interface, a wireless user interface, a direct data upload, a wireless data upload, and a line-of-sight data upload. With a direct user interface, a user manually inputs data through the front panel of a user interface. With a wireless user interface, a user manually inputs data through the user interface of an appropriately formatted wireless device. Direct data upload provides a user with direct device transfer to the system. Wireless data upload provides a user with a data upload through a wireless proximity activated memory device. With a line-of-sight upload, a user uploads data through line-of-sight transmissions from a compliant personal device.

The data retrieval process includes, in various embodiments, direct data download, a wireless user interface, wireless data download, and line of sight data download. The wireless transmission protocols supported include Bluetooth, WiFi, GSM, cellular, proprietary RF protocols, infra-red transmission protocols, and proprietary line of sight protocols.

In various embodiments, the system includes a data authentication process to assure the validity of data inputs and time and date stamps. This authentication process includes authentication codes for each vehicle trip entry, which are verified through algorithmic check routines. In one embodiment, the data authentication process includes the use of robust digital signatures to, for example, collect identifying information from a vehicle such as a serial number.

In one exemplary embodiment, the technology provides a vehicle odometer and trip data collection system for use in a motor vehicle. The system includes an interface unit for entering user input data into the vehicle odometer and trip data collection system, a portable, removable memory unit configured for data storage use within the interface unit and for data retrieval use when utilized outside of the interface unit in a memory reader device, and a means for automatic data collection to capture and authenticate data from a plurality of vehicle sensors and a plurality of external sources, the data collection including a plurality of time and date data, a plurality of vehicle odometer values, and a plurality of global positioning system coordinates and values.

The interface unit for entering user input data into the vehicle odometer and trip data collection system in one embodiment further includes a scroll groove. The scroll groove includes one or more light emitters located within the scroll groove and one or more optical sensors located within the scroll groove to detect a plurality of inputs and selections from a user. Alternatively, the scroll groove includes a segmented conductive surface located on a side of the scroll groove to sense when, and where, a user's finger is touching the scroll groove.

The interface unit of the vehicle odometer and trip data collection system also includes a microprocessor configured to process and control a plurality of data inputs, user inputs, communications operations, and recording operations, an on-board non-volatile memory for data storage, a display screen, a port for the portable, removable memory unit, and an audio speaker.

The vehicle odometer and trip data collection system also includes an internal clock module. The time and date data is captured and utilized by the internal clock module, for example, from a NIST atomic clock transmission, a global positioning satellite transmission, a cellular network transmission, a proprietary network, and a vehicle on-board computer. The vehicle odometer and trip data collection system also includes an interface module for accessing data from the on-board computer and diagnostic systems of the motor vehicle.

In another exemplary embodiment, the technology described herein provides an interface device for trip data collection in a motor vehicle and subsequent untethered transfer of data to another device. The device includes an interface unit for entering user input data into the vehicle odometer and trip data collection system and an antenna for the untethered transfer of data. The device also includes a means for automatic data collection to capture and authenticate data from a plurality of vehicle sensors and a plurality of external sources, the data collection including a plurality of time and date data, a plurality of vehicle odometer values, and a plurality of global positioning system coordinates and values.

The interface device for trip data collection in a motor vehicle in one exemplary embodiment includes a scroll groove. The scroll groove includes one or more light emitters located within the scroll groove and one or more optical sensors located within the scroll groove to detect a plurality of inputs and selections from a user. Alternatively, the scroll groove includes a segmented conductive surface located on a side of the scroll groove to sense when, and where, a user's finger is touching the scroll groove.

The interface unit device for trip data collection in a motor vehicle also includes a wireless interface module configured to operate with the antenna for the untethered transfer of data and to wirelessly transfer data to an external destination. Optionally, the device includes a line-of-sight port to optically transfer data to an external destination.

The interface unit device for trip data collection in a motor vehicle also includes a microprocessor configured to process and control a plurality of data inputs, user inputs, communications operations, and recording operations, an on-board non volatile memory for data storage, a display screen; and an audio speaker. The device also includes an internal clock module to capture and process the plurality of time and date data. The device further includes an interface module for accessing data from the on-board computer(s) and diagnostic systems of the motor vehicle. In one embodiment the interface unit derives its power from an on-board diagnostics port of the motor vehicle.

In yet another exemplary embodiment, the technology described herein provides a vehicle odometer and trip data collection system for use in a motor vehicle.

The system includes a below dash unit inconspicuously located in the vehicle and having a means for automatic data collection to capture and authenticate data from a plurality of vehicle sensors and a plurality of external sources, the data collection including a plurality of time and date data, a plurality of vehicle odometer values, and a plurality of global positioning system coordinates and values. The system includes a wireless interface unit configured to wirelessly communicate with the below dash unit and provide a user interface. The system also includes a portable, removable memory unit configured for data storage use within the interface unit and for data retrieval use when utilized outside of the interface unit in a memory reader device.

The below dash unit further includes a microprocessor configured to process and control a plurality of data inputs, user inputs, communications operations, and recording operations, an on-board non-volatile memory for data storage, an audio speaker, and a means for radio frequency data transmission and receipt for communicating with the wireless interface unit. In one embodiment, the below dash unit further includes an RF power transmitter.

The wireless interface unit further includes a means for accepting input user data, a microprocessor configured to process and control a plurality of data inputs, user inputs, communications operations, and recording operations, an on-board non-volatile memory for data storage, a display screen, a port for the portable, removable memory unit, a battery power source, and a means for radio frequency data transmission and receipt for communicating with the below dash unit. In one embodiment the wireless interface unit further includes an RF power harvester configured to provide full power or trickle charge to a battery power source.

The vehicle odometer and trip data collection system in one embodiment includes the means for accepting user input data through a scroll groove. The scroll groove includes one or more light emitters located within the scroll groove and one or more optical sensors located within the scroll groove to detect a plurality of inputs and selections from a user. Alternatively, the scroll groove includes a segmented conductive surface located on a side of the scroll groove to sense when, and where, a user's finger is touching the scroll groove.

The vehicle odometer and trip data collection system includes an internal clock module to capture and process the plurality of time and date data. The below dash unit also includes an interface module for accessing data from on-board computer(s) and diagnostic systems of the motor vehicle.

Advantageously, this technology provides a vehicle odometer and trip data collection system with automated data collection, user input data collection, data authentication, and data retrieval. Additionally, the vehicle odometer and trip data collection system provides, in one embodiment, connectivity to NIST atomic clock transmissions, global positioning satellite systems, cellular networks, and the like. Furthermore, this technology provides vehicle monitoring utilizing an interface unit, a removable memory unit, wireless transmission protocols, and radio frequency power harvesting that increases battery life in the system.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like system components and/or method steps, respectively, and in which:

FIG. 1 is a front planar view of an interface unit, according to an embodiment of the technology, illustrating, in particular, the electronic display panel, button, button lens, and scroll groove;

FIG. 2 is a planar bottom view of the interface unit of FIG. 1, illustrating, in particular, an interface unit casing and a mounting bracket groove;

FIG. 3 is a planar left side view of the interface unit of FIG. 1, illustrating, in particular, an interface unit casing and a mounting bracket groove;

FIG. 4 is a planar right side view of the interface unit of FIG. 1, illustrating, in particular, an interface unit removable memory port;

FIG. 5 is a planar side view of an interface unit mounting clip, according to an embodiment of the technology;

FIG. 6 is the planar side view of the interface unit mounting clip of FIG. 5, shown attached to an interface unit;

FIG. 7 is a planar bottom view of the interface unit mounting clip of FIG. 5, shown attached to an interface unit;

FIG. 8 is a cross-sectional view of the interface unit of FIG. 1, according to an embodiment of the technology;

FIG. 9 is a front perspective view of the interface unit of FIG. 1, illustrating, in particular, the electronic display panel, button, button lens, and scroll groove;

FIG. 10 is a front perspective view of an under dash unit, according to an embodiment of the technology;

FIG. 11 is a perspective view of a removable memory unit, according to an embodiment of the technology, illustrating, in particular, an inserted memory card and an attached end cap;

FIG. 12 is a perspective view of the removable memory unit of FIG. 11, illustrating, in particular, a USB compliant connector, a detached end cap, and a memory card before insertion;

FIG. 13 is a schematic diagram of the interface unit of FIG. 1 and the under dash of FIG. 10, unit according to an embodiment of the technology, illustrating, in particular, the interconnectivity between components of the interface unit and components of the under dash unit;

FIG. 14 is a flowchart diagram illustrating steps of user interaction in a vehicle equipped with an interface unit, according to an embodiment of the technology;

FIG. 15 is a flowchart diagram illustrating steps of user interaction with the interface unit;

FIG. 16 is a flowchart diagram illustrating steps of user interaction with the interface unit; and

FIG. 17 is a flowchart diagram illustrating steps of user interaction with the interface unit and the associated insertion of a USB flash drive.

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

In various exemplary embodiments, the technology described herein provides a vehicle odometer and trip data collection system for use in a motor vehicle. The vehicle odometer and trip data collection system provides automated data collection, user input data collection, data authentication, and data retrieval. The vehicle odometer and trip data collection system provides connectivity to systems such as NIST atomic clock transmissions and global positioning satellite (GPS) systems. Optionally, NIST and GPS data is entered in manually by a user. Additionally, this technology provides vehicle monitoring utilizing an interface unit, a removable memory unit, wireless transmission protocols, and radio frequency power harvesting. Other comparable uses are also contemplated herein, as will be obvious to those of ordinary skill in the art.

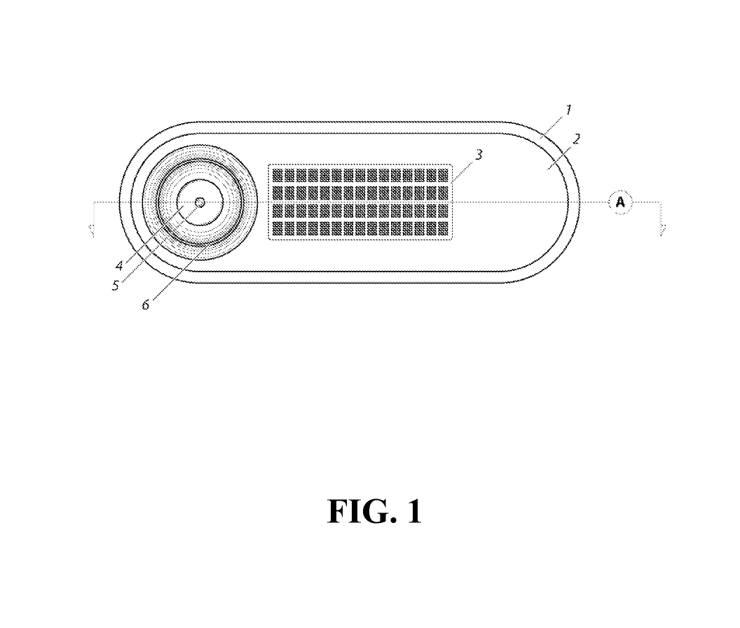

Referring now to FIG. 1, an interface unit is shown. The interface unit is enclosed with an interface unit casing 1. The interface unit casing 1 is made of a durable material to provide form and protection to the interface unit and to contain components within the interface unit. The front of the interface unit includes a face panel 2. The face panel 2 is, for example, of a clear material that is approximately 0.125 inches in thickness, such as a polycarbonate plastic. The front of the interface unit includes an electronic display panel 3. The electronic display panel 3 is an alpha-numeric display panel. The electronic display panel 3 is an LED or LCD display panel, for example.

The interface unit includes a button 4, a button lens 5, and a scroll groove 6. Together the button 4, a button lens 5, and a scroll groove 6 allow a user to access an interface menu and make input and selections to the interface unit. The button lens 5 contains a light emitter. In one embodiment, the scroll groove 6 is a scroll groove including one or more light emitters located within the scroll groove and one or more optical sensors located within the scroll groove to detect a plurality of inputs and selections from a user. In an alternative embodiment, the scroll groove includes a segmented conductive surface located on a side of the scroll groove to sense when, and where, a user's finger is touching the scroll groove.

The interface unit is placed in a vehicle and wired to a plurality of vehicle sensors with cables. For example, this cabling is achieved through the on-board diagnostics of the vehicle. The cable runs to the device through the vehicle dashboard as the user desires. The interface unit is attached to a dashboard, console, visor, or windshield of the vehicle with adhesive, a removable mounting device, an elastic band, or the like. The interface unit is configured to connect to the vehicle power supply such as through direct wiring or by accessing power pins through available ports such as the on-board diagnostics port.

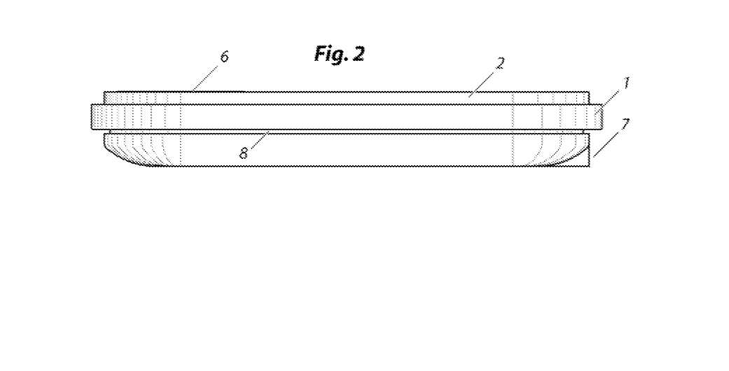

Referring now to FIG. 2, an interface unit is shown. The view of the bottom edge of the interface unit illustrates the interface unit casing 1, the face panel 2, and the scroll groove 6. Additionally, the interface unit includes a removable memory port 7 and a mounting bracket groove 8. The mounting bracket groove 8 is utilized to secure the interface unit to the vehicle in a secure manner.

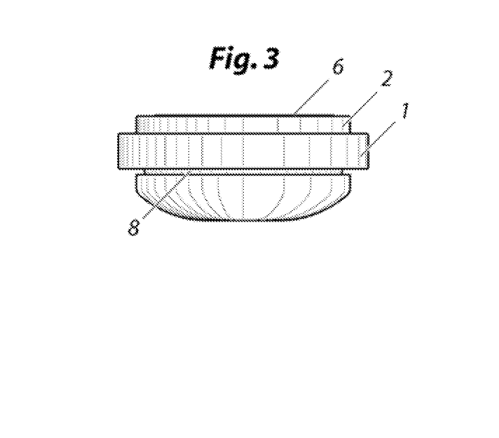

Referring now to FIG. 3, an interface unit is shown. The left edge view of the interface unit illustrates the interface unit casing 1, the face panel 2, and the scroll groove 6. Additionally, the interface unit includes a mounting bracket groove 8.

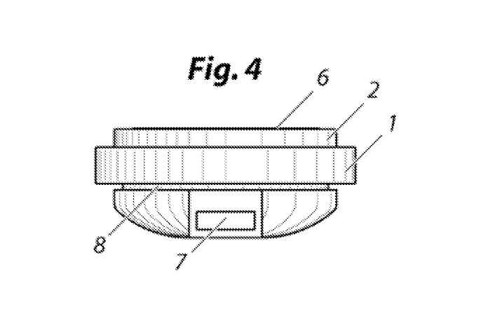

Referring now to FIG. 4, an interface unit is shown. The right edge view of the interface unit illustrates the interface unit casing 1, the face panel 2, and the scroll groove 6. Additionally, the interface unit includes a mounting bracket groove 8 utilized to secure the interface unit to the vehicle in a secure manner and the removable memory port 7 which is configured to receive a memory stick, or the like.

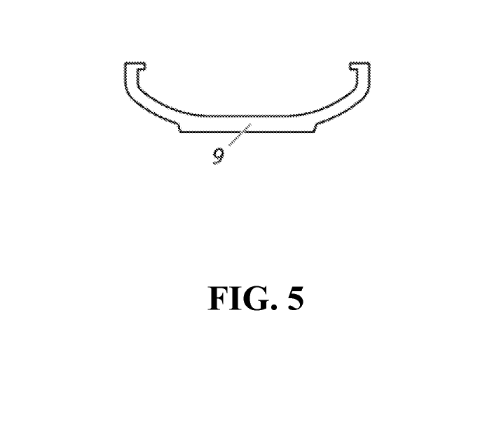

Referring now to FIG. 5, an interface unit mounting clip 9 is shown. The interface unit mounting clip 9 is made of metal, a durable plastic material, or the like, such that is has the strength to support the weight of the interface unit. The interface unit mounting clip 9 mounts to the interface unit in the mounting bracket groove 8.

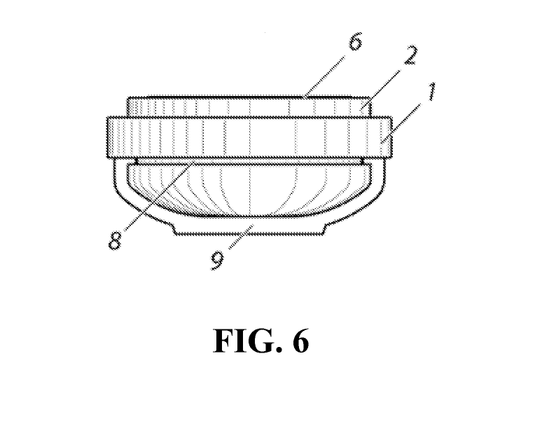

Referring now to FIG. 6, an interface unit mounting clip 9 is shown attached to an interface unit from a side view. The interface unit mounting clip 9 mounts to the interface unit in the mounting bracket groove 8. The interface unit casing 1, the face panel 2, and the scroll groove 6 are also shown.

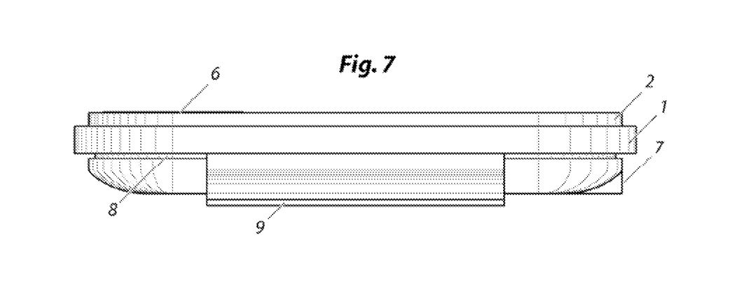

Referring now to FIG. 7, an interface unit mounting clip 9 is shown attached to an interface unit from a bottom view. The interface unit mounting clip 9 mounts to the interface unit in the mounting bracket groove 8. The interface unit casing 1, the face panel 2, the scroll groove 6, and the removable memory port 7 are also shown.

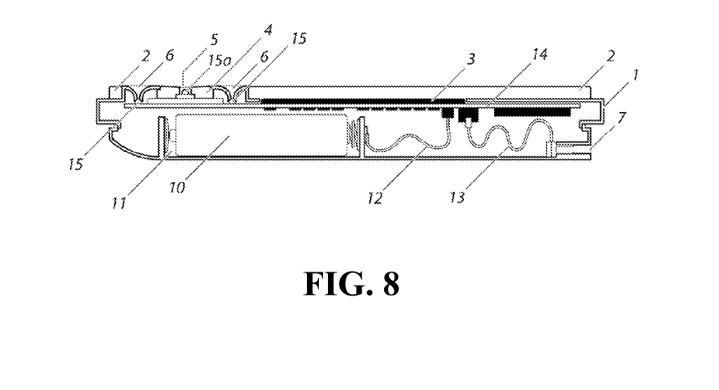

Referring now to FIG. 8, an interface unit is shown in a cross-sectional view. The interface unit is enclosed with an interface unit casing 1. The front of the interface unit includes a face panel 2. The front of the interface unit includes an electronic display panel 3. The interface unit includes a button 4, a button lens 5, and a scroll groove 6. Together the button 4, a button lens 5, and a scroll groove 6 allow a user to access an interface menu and make input and selections to the interface unit. The button lens 5 contains a light emitter 15a. The scroll groove 6 includes optical sensors 15. The interface unit includes a removable memory port 7 which is configured to receive a memory stick, or the like. The interface unit includes a battery 10, such as AA battery for example. The battery 10 is located within the battery holder 11. A wire lead 12 connects the battery 10 to the main circuit board 14. A data cable 13 is utilized to connect the removable memory port 7 to the main circuit board 14.

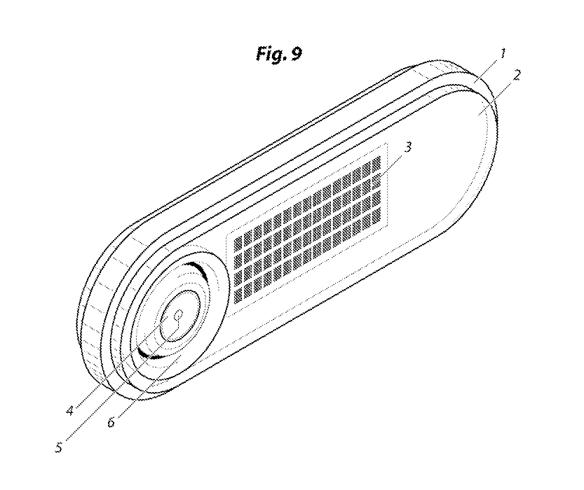

Referring now to FIG. 9, an interface unit is shown. The interface unit is enclosed with an interface unit casing 1. The interface unit casing 1 is made of a durable material to provide form and protection to the interface unit and to contain components within the interface unit. The front of the interface unit includes a face panel 2. The face panel 2 is, for example, of a clear material that is approximately 0.125 inches in thickness, such as a polycarbonate plastic. The front of the interface unit includes an electronic display panel 3. The electronic display panel 3 is an alpha-numeric display panel. The electronic display panel 3 is an LED or LCD display panel, for example. The interface unit includes a button 4, a button lens 5, and a scroll groove 6. Together the button 4, a button lens 5, and a scroll groove 6 allow a user to access an interface menu and make input and selections to the interface unit. The button lens 5 contains a light emitter. In one embodiment, the scroll groove 6 is a scroll groove including one or more light emitters located within the scroll groove and one or more optical sensors located within the scroll groove to detect a plurality of inputs and selections from a user. In an alternative embodiment, the scroll groove includes a segmented conductive surface located on a side of the scroll groove to sense when, and where, a user's finger is touching the scroll groove.

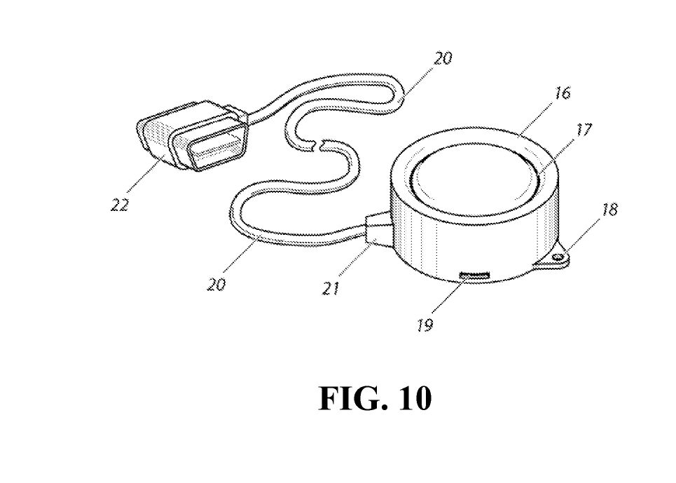

Referring now to FIG. 10, a below dash unit is shown. The below dash unit is contained in a below dash unit casing 16. Along the bottom edge of the below dash unit casing 16 is a mounting bracket 18. The mounting bracket 18 operates with a screw or rivet mounting, or the like. The below dash unit is also capable of being mounted via a zip tie. The below dash unit casing 16 includes a slot 19 for a zip tie mounting strap to pass through the below dash unit before mounting. The below dash unit is utilized in a vehicle under a dashboard. The below dash unit is configured to connect to a wireless interface unit. A light emitting groove 17 is located on the top circumference of the below dash unit. The light emitting groove 17 is used to indicate that power has reached the below dash unit. Additionally, the light emitting groove 17 is used to indicate when data is being transmitted to and from a wireless interface unit. The below dash unit includes an OBD II (on-board diagnostics) compliant pass-through connector 22. The OBD II compliant pass-through connector 22 is connected to the below dash unit with a multi-conductor cable 20. The below dash unit includes a cable strain relief 21 along its base to protect the connectivity to the multi-conductor cable 20.

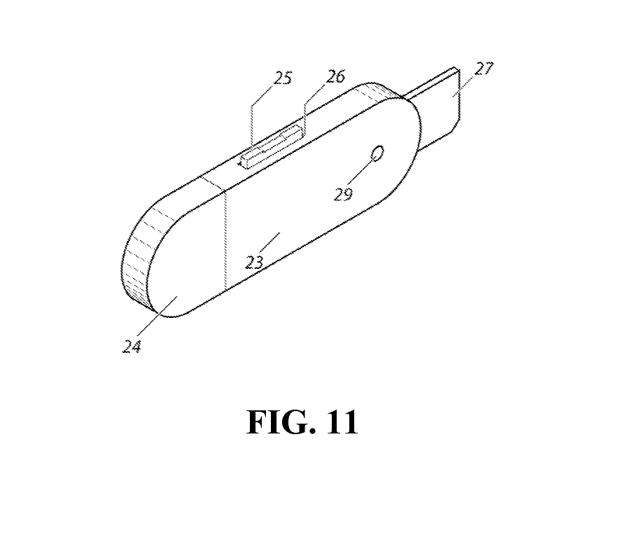

Referring now to FIG. 11, a removable memory unit is shown. The memory unit is utilized in connection with the interface unit or the wireless interface unit to provide portable, removable storage. The removable memory unit is contained in a casing 23 having a removable USB connector cap 24. The removable memory unit includes a memory card port 26 into which a memory card 25 is inserted. Memory cards are well-known in the art and are commercially available. An activity light indicator 29 is located on a side of the removable memory unit. The activity light indicator 29 emits light when the removable memory unit is in use and data is being stored or accessed. The removable memory unit 27 includes a connector 27 to connect to a memory port of the wireless interface unit or other compliant devices.

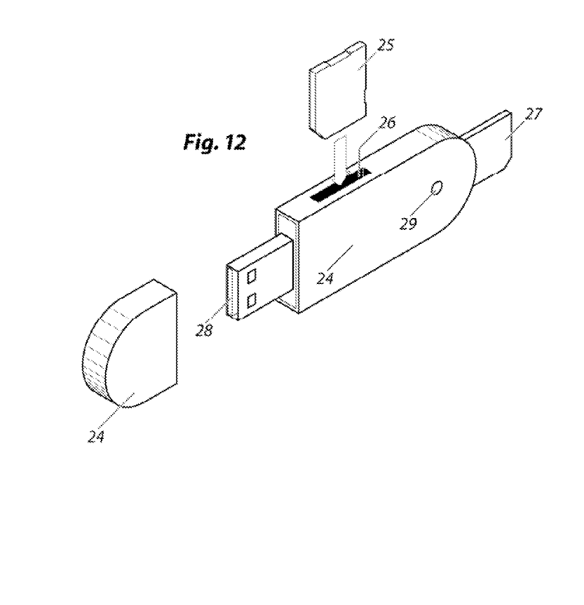

Referring now to FIG. 12, a removable memory unit is shown. The removable memory unit is contained in a casing 23 having a removable USB connector cap 24. When the removable USB connector cap 24 is removed, a USB compliant connector 28 is accessible. The removable memory unit includes a memory card port 26 into which a memory card 25 is inserted. The memory card 25 is shown here as it is being inserted into the memory card port 26. An activity light indicator 29 is located on a side of the removable memory unit. The activity light indicator 29 emits light when the removable memory unit is in use and data is being stored or accessed. The removable memory unit 27 includes a connector 27 to connect to a memory port of the wireless interface unit or other compliant devices.

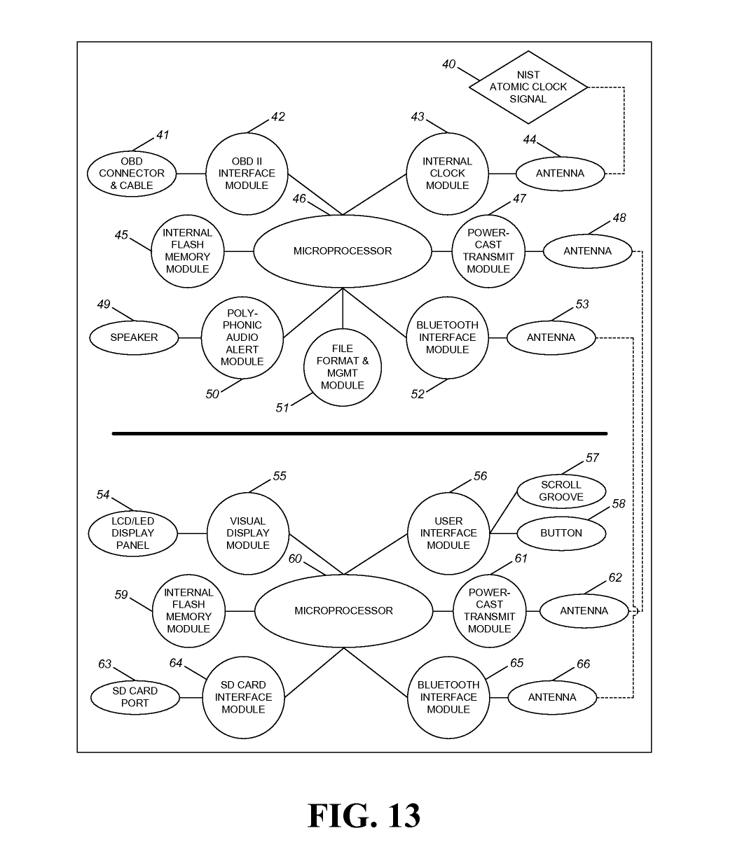

Referring now to FIG. 13, a below dash unit and an above dash unit are shown in modular form, illustrating one embodiment of the technology described herein and the interactivity of the various components of the vehicle odometer and data collection device. The below dash unit includes a microprocessor 46. The microprocessor 46 is, in various embodiments, electronically coupled to an internal clock module 43, RF power transmitting module 47, a wireless interface module 52, a file format and management module 51, a polyphonic audio alert module 50, and internal flash memory module 45, and a vehicle on-board diagnostics (OBD) interface module 42.

The internal clock module 43 captures and manages time and date data. The internal clock module 43 includes an antenna 44 for connectivity with a source for time and date information. In various embodiments, the sources for time and date data collection include, for example, NIST atomic clock transmissions 40, GPS satellite transmissions, cellular network transmissions, proprietary network transmissions, and vehicle on-board computers.

The RF power transmitting module 47 includes an antenna 48. RF power transmitting allows for the transformation of radio waves into DC voltage. This DC voltage is utilized to power an interface unit or to trickle-charge a battery in the interface unit or other component of the vehicle odometer and data collection device in need of a DC power. An RF power transmitting module is a programmable frequency source for use with RF power harvesting applications. One commercial example of RF power transmitting and harvesting is the POWERCAST Wireless Power Platform™ Transmitter Module and the Wireless Power Platform™ Receiver Module.

The wireless interface module 52 is utilized to wirelessly retrieve and/or send data. The wireless interface module 52 includes an antenna 53 to connect to an interface unit or other device or service. The data retrieval process includes, in various embodiments, direct data download, a wireless user interface, wireless data download, and line of sight data download. The wireless transmission protocols supported include Bluetooth, WiFi, GSM, cellular, proprietary RF protocols, infra-red transmission protocols, and proprietary line of sight protocols.

The file format and management module 51 provides data storage and access to a user. For example, using a compatible personal computing device, a user transfers data from the removable memory unit to the computer. The user accesses and utilizes the data using, for example, standard spreadsheet software, a database capable of reading comma-separated value files, accounting software capable of reading comma-separated value files, accounting software that automatically imports and uses the data provided through a partnership with the manufacturer, and/or tax preparation software that automatically imports and uses the data provided through a partnership with the manufacturer.

The polyphonic audio alert module 50 includes a speaker 49. The polyphonic audio alert module 50 provides a user with appropriate audio alerts from the vehicle odometer and data collection device.

The internal flash memory module 45 is coupled to the microprocessor 46 and provides an on-board non-volatile memory for data storage.

The vehicle on-board computer and diagnostic systems interface module 42 includes a compliant connector and cable 41. In a preferred embodiment, this technology utilizes the OBD II standards for vehicle on-board diagnostics. In various embodiments, the sources for vehicle odometer values include on-board diagnostics (OBD) port data feeds, direct connection to a vehicle on-board computer, and mechanical and electrical sensors mounted to the vehicle.

The above dash unit includes a microprocessor 60. The microprocessor 60 is, in various embodiments, electronically coupled to a user interface module 56, an RF power transmitting module 61, a wireless interface module 65, a removable memory card interface module 64, an internal flash memory module 59, and a visual display module 55.

The user interface module 56 includes a button 58 and a scroll groove 57 with which a user makes various selections in use of the vehicle odometer and data collection device. The scroll groove 57, in one embodiment, is a scroll groove and includes one or more light emitters located within the scroll groove and one or more optical sensors located within the scroll groove to detect a plurality of inputs and selections from a user. Alternatively, the scroll groove includes a segmented conductive surface located on a side of the scroll groove to sense when, and where, a user's finger is touching the scroll groove.

The RF power transmitting module 61 includes an antenna 62. RF power transmitting allows for the transformation of radio waves into DC voltage. This DC voltage is utilized to power an interface unit or to trickle-charge a battery in the interface unit or other component of the vehicle odometer and data collection device in need of a DC power. An RF power transmitting module is a programmable frequency source for use with RF power harvesting applications. One commercial example of RF power transmitting and harvesting is the POWERCAST Wireless Power Platform™ Transmitter Module and the Wireless Power Platform™ Receiver Module.

The wireless interface module 65 is utilized to wirelessly retrieve and/or send data. The wireless interface module 65 includes an antenna 66 to connect to an interface unit or other device or service. The data retrieval process includes, in various embodiments, direct data download, a wireless user interface, wireless data download, and line of sight data download. The wireless transmission protocols supported include Bluetooth, WiFi, GSM, cellular, proprietary RF protocols, infra-red transmission protocols, and proprietary line of sight protocols.

The removable memory card interface module 64 includes a memory card port 63. The removable memory card interface module 64 is utilized in connection with the interface unit or the wireless interface unit to provide portable, removable storage.

The internal flash memory module 59 is coupled to the microprocessor 60 and provides an on-board non-volatile memory for data storage.

The visual display module 55 is electronically coupled to an electronic display panel 54. The electronic display panel 54 is an alpha-numeric display panel. The electronic display panel 54 is an LED or LCD display panel, for example. The electronic display panel 54 provides a user with instructions, menu options, etc. for use of the vehicle odometer and data collection device.

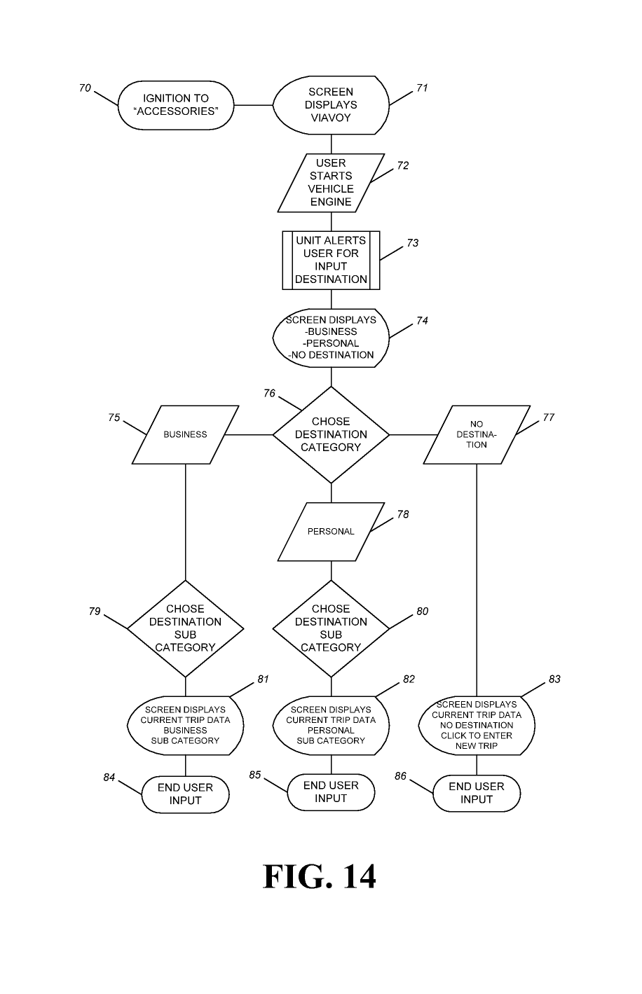

Referring now to FIG. 14, a flowchart diagram illustrating steps of user interaction in a vehicle equipped with an interface unit is shown. As a user enters a vehicle and turns the ignition switch to the “Accessories” position 70, the vehicle odometer and data collection device initializes and displays a welcome screen 71. The vehicle engine is then started 72 at the determination of the user. The vehicle odometer and data collection device alerts the user for in input destination 73 and the visual display screen displays, for example, “Business? Personal? No Destination?” in a menu of choices 74 for the user to select using the scroll grove. A user is presented with a decision to choose a destination 76, selecting between Business 75, Personal 78, and No Destination 77, for example. If a user selects Business 75, the user is prompted to choose a business destination subcategory 79, and the screen displays a menu listing business destination subcategories 81. Once the user has selected a business destination subcategory 81, user input ends 84 for this selection. If a user selects Personal 78, the user is prompted to choose a personal destination subcategory 80 and the screen displays a menu listing personal destination subcategories 82. Once the user has selected a personal destination subcategory 81, user input ends 85 for this selection. If a user selects no destination 77, the screen displays an option for the user to enter a new trip 83. Once the user enters the new trip user input ends 86 for this selection.

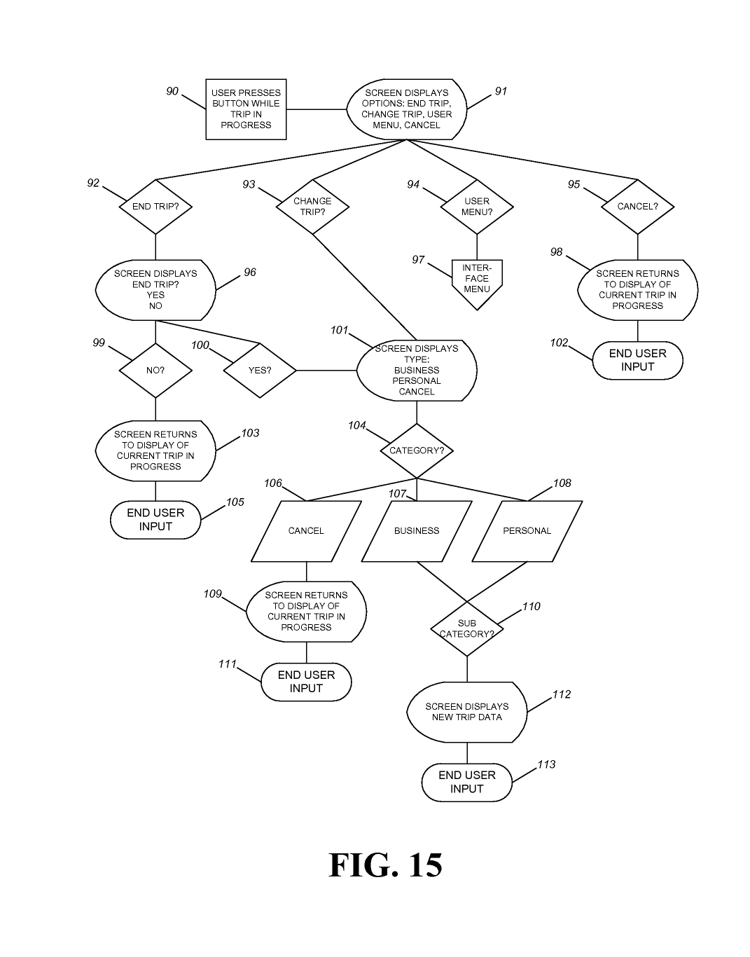

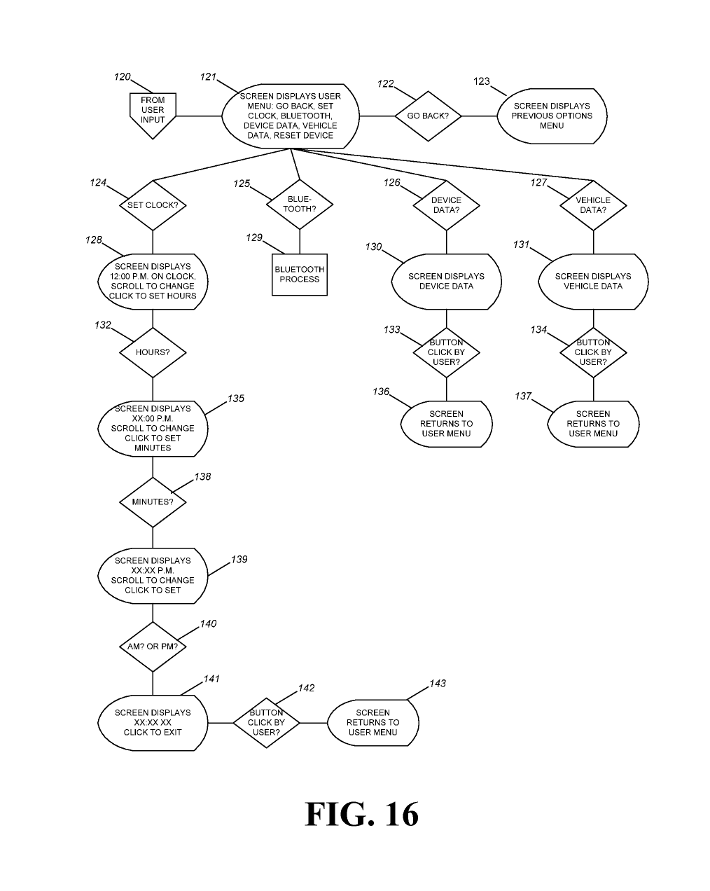

Referring now to FIG. 15, a flowchart diagram illustrating steps of user interaction with the interface unit is shown. While a vehicle trip is in progress, a user selects the button on the interface unit 90. The visual display screen displays the following options, for example: End Trip? Change Trip? User Menu? and Cancel? 91. The user selects one of End trip? 92 Change trip? 93 User Menu? 94 and Cancel? 95. If a user selects End Trip? 92, the screen displays End Trip? Yes? No? 96, prompting the user to make a “No” 99 or a “Yes” 100 decision. If a user selects “No” 99, to not end the trip recordation, the screen returns to displaying the current trip in progress 103 and ending user input 105. If the user selects “Yes” 100, to end the trip recordation, the screen displays Business? Personal? Cancel? 101, prompting the user. If a user selects Change Trip 93, the screen displays Business, Personal, Cancel, prompting the user to make a selection of category 104. The user selects Cancel 106, Business 107, or Personal 108. As Cancel is selected 106, the screen returns to a display of the current trip in progress 109 and user input ends 111. As Business is selected 107 or as Personal 108 the user is prompted for a subcategory 110 and the screen displays new trip data. User input then ends 113. As a user selects User Menu 94, the user is redirected to an interface menu 97 (further disclosed in FIG. 16). As a user selects Cancel 95, the screen returns to a display of the current trip in progress 98 and user input ends 102.

Referring now to FIG. 16, a flowchart diagram illustrating steps of user interaction with the interface unit, specifically the user menu options is shown. As a user selects User Menu 94 (as shown in FIG. 15), the user is redirected to an interface menu from the user input 120. A screen displays for the user the following options, for example: Go back? Set clock? Bluetooth? Device data? Vehicle data? And Reset Device 121. The user is thus presented with the decisions Go Back? 122, Set Clock? 124, Bluetooth? 125, Device Data? 126, and Vehicle Data? 127. As a user selects Go back? 122, the screen displays the previous options menu 123. As a user selects Set Clock? 124, the screen displays the time, prompting the user to changes the hours, 128, 132. Subsequently, a screen displays the time prompting the user to change the minutes 135, 138. The user is then shown the time and prompted to change the AM or PM setting 139, 140. The set clock is then displayed on the screen 141, prompting the user to exit if desired. As a user pushes the button 142, the screen returns the user to the main user menu 143. As a user selects Bluetooth? 125, a Bluetooth process 129 is initiated. As a user selects Device data? 126, the screen displays relevant device data 130 for the user to review. As a user pushes the button 133, the screen returns the user to the main user menu 136. As a user selects Vehicle data? 127, the screen displays relevant vehicle data 131 for the user to review. As a user pushes the button 134, the screen returns the user to the main user menu 137.

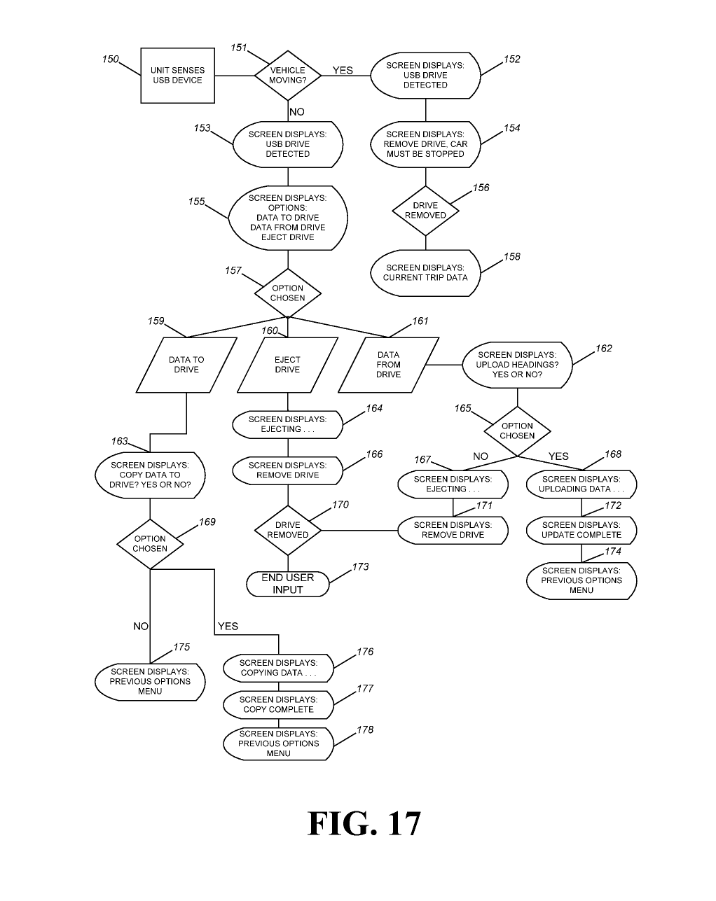

Referring now to FIG. 17, a flowchart diagram illustrating steps of user interaction with the interface unit and the associated insertion of a USB flash drive is shown. The unit senses the presence of a USB drive 150 and determines whether the vehicle is moving 151. If the vehicle is moving, the screen displays USB Drive Detected 152 and then displays Remove Drive, Car Must Be Stopped 154. The system verifies the drive has been removed 156 and displays current trip data 158. If the vehicle is not moving, the screen displays USB Drive Detected 152 and then subsequently displays user options: Data to drive, Data from drive, and Eject Drive 155. A user then chooses one of the presented options 157, selecting Data to drive 159, Data from drive 161, or Eject Drive 160. As the user selects Data to drive 159, the screen displays Copy data to drive: Yes? No?, prompting the user to chose an option 169. If the user selects No, the screen displays the previous options menu 175. If the user selects Yes, the screen displays Copying Data 176, Copy Complete 177, and subsequently returns to the previous options menu 178. As the user selects Data from drive 161, the screen displays Upload Headings? Yes? No? 162, prompting the user to select an option 165. If the user selects No at 165, the screen displays Ejecting 167 and then Remove Drive 171. Once it is verified that the drive is removed 170, user input is ended 173. If the user selects Yes at 165, the screen displays Uploading Data 168 and then Update Complete 172 once the data transfer is finalized. The screen then displays the previous options menu 174. As the user selects Eject Drive 160, the screen displays Ejecting Drive 164 and then Remove Drive 166. Once it is verified that the drive is removed 170, user input is ended 173.

In one exemplary embodiment, the user experiences the following. Upon entering the vehicle, the user starts the engine. The below dash unit (BDU) powers up and begins transmitting RF energy through the built-in RF power transmitter The BDU senses the ignition start through data communications from the vehicle sensors. Using wireless transmission, the BDU transmits a signal to the wireless interface unit (WIU) to wake the unit from its power-saving “sleep” mode. The WIU's internal power harvester absorbs the energy transmitted by the BDU RF power transmitter and charges the WIU's internal batteries. The BDU uses audio tones to alert the driver that the device requires user input. The display screen on the WIU prompts the user to select a destination category, such as business, personal, or no destination. By sliding a finger across the scroll groove on the device, the user scrolls through the options list. The user stops the cursor on the appropriate category and clicks the button to choose the category desired. Through the WIU display, the device then requests a sub-category to be selected from the list of user customizable choices, such as, for example, Office, Airport, Client, Warehouse, etc. Utilizing the scroll groove and the button on the WIU, the user scrolls through the list and selects the appropriate subcategory. The WIU now displays the trip category, subcategory, and 0.0 miles. The device records the time, date, current odometer value, destination category and subcategory to the on-board memory in the device. The user proceeds to drive the vehicle to the destination. Upon shutting off the vehicle, the device adds the end trip data (time, date, current odometer value, etc.) to the record already recorded in the on-board memory. Each time the user starts the ignition, the user is prompted to enter the destination data. The unit then adds the new trip data to the data files previously recorded in the device on-board memory.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

1. A vehicle odometer and trip data collection system for use in a motor vehicle, the system comprising:
an interface unit for entering user input data into the vehicle odometer and trip data collection system;
a portable, removable memory unit configured for data storage use within the interface unit and for data retrieval use when utilized outside of the interface unit in a memory reader device; and
a means for automatic data collection to capture and authenticate data from a plurality of vehicle sensors and a plurality of external sources, the data collection including a plurality of time and date data, a plurality of vehicle odometer values, and a plurality of global positioning system coordinates and values.

2. The vehicle odometer and trip data collection system for use in a motor vehicle of claim 1, wherein the interface unit for entering user input data into the vehicle odometer and trip data collection system further comprises a scroll groove.

3. The vehicle odometer and trip data collection system for use in a motor vehicle of claim 1, wherein the interface unit further comprises:
a microprocessor configured to process and control a plurality of data inputs, user inputs, communications operations, and recording operations;
an on-board non-volatile memory for data storage;
a display screen;
a port for the portable, removable memory unit; and
an audio speaker.

4. The vehicle odometer and trip data collection system for use in a motor vehicle of claim 2, wherein the scroll groove further comprises:
one or more light emitters located within the scroll groove; and
one or more optical sensors located within the scroll groove to detect a plurality of inputs and selections from a user.

5. The vehicle odometer and trip data collection system for use in a motor vehicle of claim 2, wherein the scroll groove further comprises:
a segmented conductive surface located on a side of the scroll groove to sense when, and where, a user's finger is touching the scroll groove.

6. The vehicle odometer and trip data collection system for use in a motor vehicle of claim 1, further comprising:
an internal clock module; and
wherein the plurality of time and date data is captured from a NIST atomic clock transmission and received by the internal clock module.

7. The vehicle odometer and trip data collection system for use in a motor vehicle of claim 1, further comprising:
an internal clock module; and
wherein the plurality of time and date data is captured from a global positioning satellite transmission and received by the internal clock module.

8. The vehicle odometer and trip data collection system for use in a motor vehicle of claim 1, further comprising:
an internal clock module; and
wherein the plurality of time and date data is captured from a cellular network transmission and received by the internal clock module.

9. The vehicle odometer and trip data collection system for use in a motor vehicle of claim 1, further comprising:
an internal clock module; and
wherein the plurality of time and date data is captured from a vehicle onboard computer and received by the internal clock module.

10. The vehicle odometer and trip data collection system for use in a motor vehicle of claim 1, further comprising:
an interface module for accessing data from the onboard electronics and diagnostic systems of the motor vehicle.

11-20. (canceled)

21. A vehicle odometer and trip data collection system for use in a motor vehicle, the system comprising:
a below dash unit inconspicuously located in the vehicle and having a means for automatic data collection to capture and authenticate data from a plurality of vehicle sensors and a plurality of external sources, the data collection including a plurality of time and date data, a plurality of vehicle odometer values, and a plurality of global positioning system coordinates and values;
a wireless interface unit configured to wirelessly communicate with the below dash unit and provide a user interface; and
a portable, removable memory unit configured for data storage use within the interface unit and for data retrieval use when utilized outside of the interface unit in a memory reader device.

22. The vehicle odometer and trip data collection system for use in a motor vehicle of claim 21, wherein the below dash further comprises:
a microprocessor configured to process and control a plurality of data inputs, user inputs, communications operations, and recording operations;
an on-board non-volatile memory for data storage;
an audio speaker; and
a means for radio frequency data transmission and receipt for communicating with the wireless interface unit.

23. The vehicle odometer and trip data collection system for use in a motor vehicle of claim 21, wherein the wireless interface unit further comprises:
a means for accepting user input data;
a microprocessor configured to process and control a plurality of data inputs, user inputs, communications operations, and recording operations;
an on-board non-volatile memory for data storage;
a display screen;
a port for the portable, removable memory unit;
a battery power source; and
a means for radio frequency data transmission and receipt for communicating with the below dash unit.

24. The vehicle odometer and trip data collection system for use in a motor vehicle of claim 21, wherein the below dash unit further comprises an RF power transmitter and wherein the wireless interface unit further comprises an RF power harvester configured to provide full power or trickle charge to a battery power source.

25. The vehicle odometer and trip data collection system for use in a motor vehicle of claim 23, wherein the means for accepting input user data comprises a scroll groove.

26. The vehicle odometer and trip data collection system for use in a motor vehicle of claim 25, wherein the scroll groove further comprises:
one or more light emitters located within the scroll groove; and
one or more optical sensors located within the scroll groove to detect a plurality of inputs and selections from a user.

27. The vehicle odometer and trip data collection system for use in a motor vehicle of claim 25, wherein the scroll groove further comprises:
a segmented conductive surface located on a side of the scroll groove to sense when, and where, a user's finger is touching the scroll groove.

28. The vehicle odometer and trip data collection system for use in a motor vehicle of claim 21, wherein the below dash unit further comprises:
an internal clock module to capture and process the plurality of time and date data.

29. The vehicle odometer and trip data collection system for use in a motor vehicle of claim 21, wherein the below dash unit further comprises:
an interface module for accessing data from the on-board computer and diagnostic systems of the motor vehicle.
